(19) United States
(12) Patent Application Publication
(10) Pub. No.: US 2003/0128234 A1
(43) Pub. Date: Jul. 10, 2003

(54) Utilizing document white space to persistently display designated content

(75) Inventors: Michael Wayne Brown, Georgetown, TX (US); Michael A. Paolini, Austin, TX (US)

Correspondence Address: Marilyn Smith Dawkins, International Business Machines Corporation, Intellectual Property Law Department, 11400 Burnet Road, Internal Zip 4054, Austin, TX, 78758, US

(73) Assignee: International Business Machines Corporation

(21) Appl. No.: 10/042,491

(22) Filed: Jan. 9, 2002

(51) Int. Cl. G09G 5/00

(52) U.S. Cl. 345/744; 345/788

(57) ABSTRACT

The system, method and program of the invention enables a Web browser or viewer program to identify the white space, i.e., background space, of a document; and to utilize the identified white space for displaying content that has been designated as content that is to be persistently displayed regardless of user actions.

### BACKGROUND OF THE INVENTION

1. Field of the Invention

The present invention relates to an improved data processing system, and more specifically, to a system, method, and program for utilizing the white space or background space of a document to persistently display designated content.

2. Description of the Related Art

As computational devices continue to proliferate throughout the world, there also continues to be an increase in the use of networks connecting these devices. A widely used network is the Internet which is a collection of networks, possibly dissimilar, that are joined together by means of gateways that handle data transfer and the conversion of messages from the sending network to the protocols used by the receiving network. A commonly employed method of transferring data over the Internet is to employ the World Wide Web (WWW) environment, referred to herein as the “Web”. In the Web environment, servers and clients effect data transfer using the Hypertext Transfer Protocol (HTTP), a known protocol for handling the transfer of various data files (e.g., text, still graphic images, audio, motion video, etc.).

A Web browser on a client enables a user to specify a Web location through a displayed link or by inputting the URL of the location in the browser. The Web browser sends the URL request using the HTTP protocol to the Internet which determines which server to send the request to. A Web server receives the request and sends the requested page to the Web browser client for display to the user.

A page is created using a markup language such as hypertext markup language (HTML), extended hypertext markup language (XML), or wireless markup language (WML). Portions of text and images within a page are delimited by indicators, which affect the format for display. In HTML documents, the indicators are referred to as tags. These markup languages generate a flowing text document in contrast to a fixed page layout such as is generated by an Adobe PDF document or documents using other fixed positioning layouts.

The Document Object Model (DOM) is a platform and language independent interface that allows programs and scripts to dynamically access and update the content, structure, and style of documents. The Document Object Model is a W3C standard for which information on the World Wide Web can be found at W3.org/DOM. The Document Object Model essentially breaks down the anatomy of a Web page into components that can be manipulated. The Document Object Model expresses the structure of an HTML document in a universal, content-neutral way. The DOM creates objects which have child objects and properties. The child objects have further child objects and properties and so on. Basically, the DOM is a hierarchical structure consisting of a top/down list from left to right of all of the elements of a Web page or document displayed on the screen. Some top level objects include:

window

location
frames
history
navigator
event
screen
document

links
anchors
images
filters
forms
applets
plug-ins
frames
scripts
stylesheets
body

When a Web browser brings down a Web page, the Web page is parsed into a tree. When the browser renders the document, the browser will go left-to-right and top-down on the tree and render each element that is in the DOM. Essentially, the DOM is a rendering tree. Since there is an API to the DOM, programming script, such as Java Script, can traverse the tree, modify the tree, and move a graphical image from one element of the tree to another element of the tree. For example, the Document Object Model enables programming script to specify an image at a location, text at a location, a frame, text within a frame, an image within a frame, etc. The browser then reflows the document (top-down, left-to-right) according to the changes made to the DOM tree as the reflowed document is rendered to the display.

A Web page can include text and other objects including image, video, and audio. A Web page can include embedded object sources, such as an image source having graphics, audio, video, and/or text, that are specified by a link to other Web content on the Internet. When a Web browser renders the requested Web page having an embedded object, “the Web browser sends a request to the server specified by the embedded link to get the content of the embedded object. When the Web browser receives the content, the Web browser renders the embedded object content as part of the Web page as defined in the markup language.

In other scenarios, the Web browser may display the Web content of the embedded object in a browser object such as another window or a frame. Browser objects are generated by the Web browser either in response to directions in the markup language of a requested page being rendered, or they can be generated by the browser independent from and separate from any specific Web page. In the latter case, content contained within the browser object originates outside the scope of the primary underlying Web page being displayed in response to a client request. Browser objects may include frames, or windows, or other objects such as other images that appear as icons. In essence though, all browser objects can be thought of in a similar way as separate browser frames or browser windows having content defined by a Web page. However, these browser objects and their “Web page” content can be considered to be secondary to the primary Web page being displayed in response to a client request. Typically, the “Web page” content of a browser object has not been specifically requested by the viewing client. Instead, for example, it can be displayed in response to operations stemming from an underlying Internet Service Provider to the client. A typical example of such secondary Web page content appearing in a browser object is advertising.

Since access to many Web pages is free to a user without having to subscribe to the Web site and pay a fee, many Web site owners try to compensate for their expenses by embedding one or more links within their Web page to advertisements. In addition, Internet Service Providers also try to minimize the cost of providing access to the Internet to its users by displaying advertising to the users using browser objects.

Several different types of problems occur depending upon whether the content, such as advertising content, is being provided for by a Web page designer, or the content is utilizing a browser object.

One problem arises when a Web page designer may have allocated too much space in the Web page for a specific advertisement retrieved by the Web browser through an embedded link. For example, FIG. 1 illustrates a Web page 100 wherein the advertisement 101 does not fully utilize the background space 102 that the Web page designer had allocated for it. Consequently, the full potential impact of the advertisement is minimized by not utilizing the full area that has been allocated to it. Also, as shown in FIG. 1, it should be noted that the advertisement 101 is at the top of the Web page 100.

The use of advertising on the Internet has become annoying to many users. The problem is not only that the advertising is becoming ubiquitous, but the problem also arises due to the manner in which specific advertising is presented on the user's display.

An annoyed user viewing the Web page of FIG. 1 would merely scroll the Web page such that the advertisement at the top of the screen would then scroll off of the screen. Consequently, the full potential impact of the advertisement is further not realized because it has been placed in a way that allows the advertisement to be scrolled off of the screen.

To avoid having a user scroll an advertisement off the screen, some Web page designers direct the Web browser to generate new frames, i.e., browser objects, for the advertisements. The location of the frames on the display screen is under the control of the Web browser, and not necessarily under the control of the designer of the primary Web page. As such, the frames may appear on the display screen in a way that obfuscates a part of the primary Web page that the user was interested in viewing. Although an action by the user on the primary Web page may cause the advertising frame to disappear, other frames may continue to reappear while a user is viewing a particular Web page. It is annoying to users to have these advertising frames or other browser objects popping onto the display screen. In some instances, the frames do not disappear from the screen unless the user makes an additional user interaction to specifically close the particular frame, resize it, or move it. This additional user interaction becomes even more annoying when it has to be repeated for each different frame that seems to continually pop into view.

This problem exists not just for advertisements, but for any browser object that appears or reappears on the display screen regardless of the user interaction with the underlying primary Web page.

For example, at a Web site on the World Wide Web at storenet.com, there is a browser object that keeps appearing on the screen regardless of how the Web page is scrolled or the Web page window is resized. The problem is that this browser object obscures some of the content of the Web page.

### SUMMARY OF THE INVENTION

It is therefore an object of the invention to enhance the advertising environment on the Internet by minimizing the annoying aspects of having advertisements appear on the display screen in a way that obscures portions of the content of the underlying primary Web page.

It is a further object of the present invention to avoid obscuring underlying content when a browser object pops on top of the primary Web page.

It is a further object of the invention to enable advertising content to appear on the display screen in a way that fully utilizes any white space or background space of the primary underlying Web page content.

It is a further object of the invention to enable designated content to be persistently displayed in a way that does not obfuscate any portion of the content of a primary document being viewed.

The system, method and program of the invention enables a Web browser or viewer program to identify the white space, i.e., background space, of a document; and to utilize the identified white space for displaying content that has been designated as content that is to be persistently displayed regardless of user actions. Specifically, a Web browser examines the primary Web page content for available white space having a size that will allow the designated content to fit within it. If no such white space is currently available as the Web page is currently being painted in its displayed frame, the browser will reflow the underlying primary content to generate the appropriate size of white space for the designated content. The browser then renders the white space filler, i.e., the designated content, and paints the display with the underlying primary Web page content with the designated content embedded in the previously available white space. If the underlying primary Web page is scrolled, or its frame resized, such that the designated content would no longer be fully visible, the browser relocates the designated content to any appropriately sized available new white space. If such new white space does not currently exist, then the browser reflows the underlying primary content to generate the appropriately sized white space. This process continues to be reiterated as needed.

### BRIEF DESCRIPTION OF THE DRAWINGS

For a more complete understanding of the present invention and the advantages thereof, reference should be made to the following Detailed Description taken in connection with the accompanying drawings in which:

FIG. 1 illustrates a Web page having an advertisement that incompletely fills available white space in accordance with the prior art;

FIG. 2 illustrates one embodiment of a computer system with which the method, system, and program of the present invention may be advantageously utilized; and

FIG. 3 illustrates the process flow and logic of a preferred embodiment of the invention.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

In the description herein the term white space is used although it is to be understood that the space may not necessarily be white; it may be any color or pattern or image. Background space and white space are used interchangeably herein.

In addition, the use of the term “images” may include any embedded object such as scaleable vector graphics and other content being rendered by another plug-in, such as Macromedia Flash.

Although a preferred embodiment of the invention is described below with reference to a Web browser and Web pages, the present invention is also applicable to other viewer programs and documents. The terms “Web pages” and “documents” are used interchangeably herein. Although all Web pages can be considered as documents, not all documents are necessarily Web pages. The present invention is not limited to Web pages, but to any document while under the control of a viewer program. Examples of Web browsers include Microsoft Internet Explorer and Netscape Navigator. An example of a viewer program is Adobe Acrobat Reader. The term viewer program when used more generally herein also includes browser programs. Likewise, the invention is applicable to all viewer programs even though the term browser program may have been used in describing a preferred embodiment. A viewer program, including browser programs, is a program that allows a file to be read, or played, but not changed. Although a viewer program may enable the display of the file to be altered or rearranged on the display screen, it does not provide any capability for editing the original source file of the document.

Although a preferred embodiment of the invention is described with reference to advertising content, the advantages of the invention are fully realized with other types of content including logos, watermarks, stock quotes, personal financial updates, weather and news updates, or other important notes or reminders that are desired to be continually displayed. All of these types of content are referred to herein as secondary content. Secondary content is content that has not been specifically requested by a user for viewing; or, if it has been requested, it is in addition to, or secondary to, primary content that the user has requested. It is this secondary content that is enabled to be persistently displayed, in accordance with a preferred embodiment of the invention, regardless of user interactions such as scrolling or frame resizing. The term “underlying primary content” is used herein to mean the content of the main document that was originally requested by the user to be displayed.

The present invention may be executed in a variety of systems, or network of systems, including a variety of computing systems and electronic devices under a number of different operating systems and networks. In one embodiment of the present invention, the computing system is a portable computing system such as a notebook computer, a palmtop computer, a personal digital assistant, a telephone or other electronic computing system that may also incorporate communications features that provide for telephony, enhanced telephony, messaging and information services. However, the computing system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

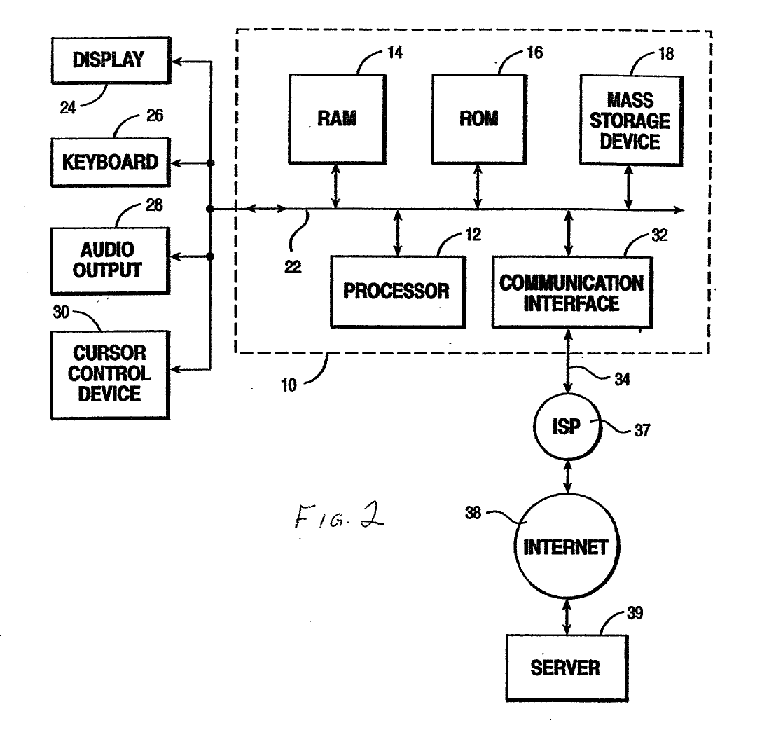

Referring now to the drawings, and in particular to FIG. 2, there is depicted one embodiment of a computer system with which the method, system, and program of the present invention may be advantageously utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

Processor 12 may be a general-purpose processor such as IBM's PowerPC” processor that, during normal operation, processes data under the control of operating system and application software stored in a dynamic storage device such as a random access memory (RAM) 14 and a static storage device such as Read Only Memory (ROM) 16. The operating system preferably provides a graphical user interface (GUI) to the user. In a preferred embodiment, application software, such as a browser program or a viewer program, contains machine executable instructions that when executed on processor 12 carry out the operations depicted in the flowcharts described herein. Alternatively, the steps of the present invention might be performed by specific hardware components that contain hardwire logic for performing the steps, or by any combination of programmed computer components and custom hardware components.

Further, multiple peripheral components may be added to computer system 10. For example, a display 24 is also attached to bus 22 for providing visual, tactile or other graphical representation formats. Audio output through a speaker or other audio projection device may be controlled by audio output device 28 attached to bus 22. A keyboard 26 and cursor control device 30, such as a mouse, track ball, or cursor direction keys, are coupled to bus 22 as interfaces for user inputs to computer system 10. It should be understood that keyboard 26 and cursor control device 30 are examples of multiple types of input devices that may be utilized in the present invention. In alternate embodiments of the present invention, additional input and output peripheral components may be added.

The present invention may be provided as a computer program product, included on a machine-readable medium having stored thereon the machine executable instructions used to program computer system 10 to perform a process according to the present invention. The term “machine-readable-medium” as used herein includes any medium that participates in providing instructions to processor 12 or other components of computer system 10 for execution. Such a medium may take many forms including, but not limited to, nonvolatile media, volatile media, and transmission media. Common forms of nonvolatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of nonvolatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide are network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital or analog data streams. The signals through the various networks and the signals on network link 34 and through communications interface 32, which carry the digital or analog data to and from computer system 10, are exemplary forms of carrier waves transporting the information.

The system, method and program of a preferred embodiment of the invention enables a Web browser or viewer program to identify the white space, i.e., background space, of a document; and to utilize the identified white space for displaying content that has been designated as content that is to be persistently displayed regardless of user actions. It should be noted that the content itself may be so designated, or an object, such as a browser object, that is to contain content, may be so designated.

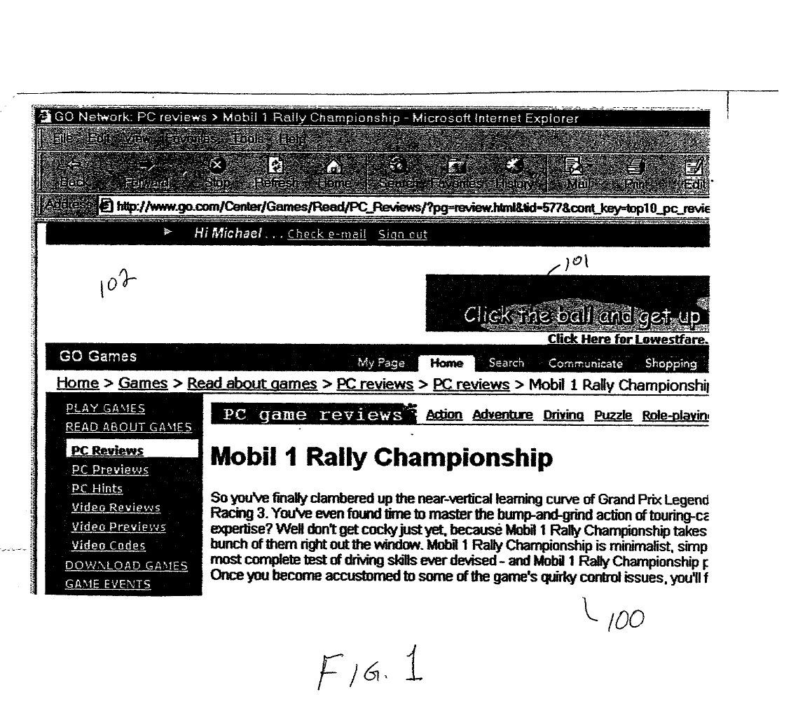

Referring back to FIG. 1, the system, method, and program of the present invention identifies the white space 102 and utilizes the white space to either enlarge the advertisement 101 such that it more fully utilizes the white space, or utilizes the white space for yet another advertisement or for other Web content of another embedded source object. As such, the browser at the client performs automatic stretching and fitting of secondary content within embedded objects. This is especially beneficial when rendering secondary Web pages, created for a certain display resolution, on a display with a different display resolution, and displaying those images to scale.

Furthermore, the browser keeps the advertising content viewable on the underlying primary Web page without obscuring the underlying primary Web page content. In response to a user scrolling the primary Web page, the browser flows the primary Web page content around the advertising content. That is, the primary Web page content flows around an embedded object such as an embedded object containing advertising content. Although it appears as though the embedded object is moving down through the text during a scrolling operation, the browser is flowing the primary Web page content upward around the embedded object.

Identifying the presence or absence of white space in a Web document can be carried out in many different ways. In one embodiment, a grid is set up for the picture elements (pixels or pels), wherein each pel within the displayed Web page is defined by a set of coordinates. At each coordinate, a 1 (or, alternatively, a 0) is set if white space exists at a given coordinate. Alternatively, a value of 0 can be used if the pel is not used or if the value of the pel is consistent with a value being used for background images, and a value of 1 can be used to indicate foreground content.

An additional method akin to this one would be to scale the pixel unit measurement into representing multiple pixels to reduce the number of pixels to keep track of, thereby saving memory space.

Another technique for determining the white space is using the nearest neighbor technique in which the size of the white space is determined by counting the number of points to the right of a previous white space point until the white space ends, and then traversing the row of white space points below the previous determined white space row and counting point after point of white space. This process continues until no more rows of white space exist. In essence, such a process determines the form or size of white space, such as a rectangle or other shape. The size of the white space is then stored (e.g., 20 points by 30 points) which requires less memory than storing a grid of each pel and whether a bit for each specific pel is on or off to represent its status as a white space. As such, the size and location of the white space is stored.

Another method uses the DOM interface to check the rectangles of a Web page. Calculations on various Web page data elements are performed before and after and during the rendering process to determine the areas of the data elements that are used. The areas for all of the Web page data elements are stored. Any remaining areas are determined to be areas of white space or background space.

In utilizing the DOM interface in a preferred embodiment of the invention, the document data elements (objects) would be drawn in the Document Object Model (DOM). When a browser brings down a primary Web page, the primary Web page is parsed into a tree. When the browser renders the primary Web page, the browser will go left-to-right and top-down on the tree and render each data element (object) that is in the DOM. Essentially, the DOM is a rendering tree. Since there is an API to the DOM, programming script, such as JAVA Script, can traverse the tree, modify the tree, and move a graphical image from one element of the tree to another element of the tree. For example, the Document Object Model enables programming script, such as Java script, to specify an image at location, text at location, frame, text within frame, an image within frame, etc. The browser would then reflow the document (top-down, left-to-right) according to the changes made to the DOM tree.

The above described determinations for white space are performed on a per simple frame basis. It is understood that there can be frames within frames. In the present invention, for simplicity, each frame is treated as a separate Web page for purposes of its layout.

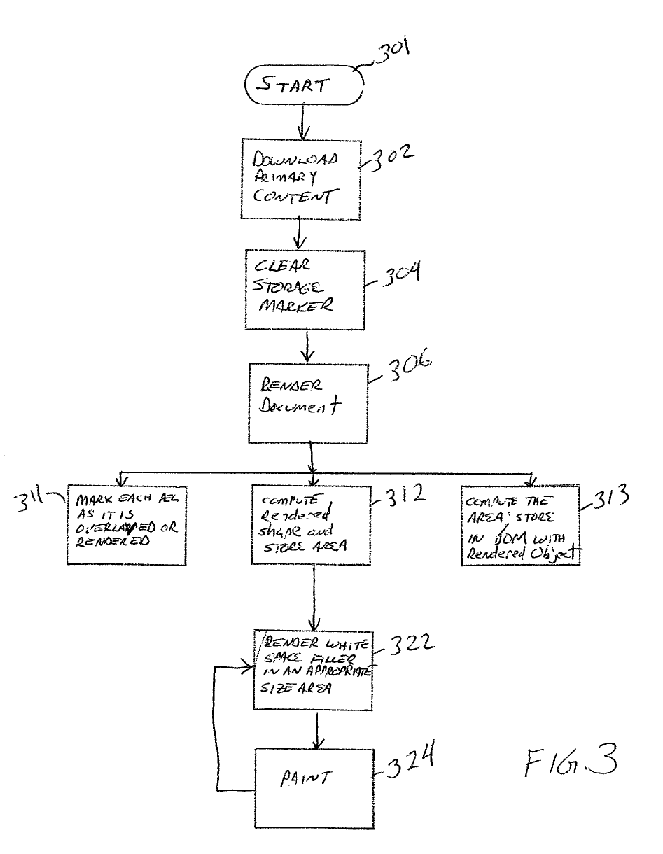

FIG. 3 illustrates an overall process flow and logic of a preferred embodiment of the invention. The process begins at step 301 and proceeds to downloading content of a primary Web page 302. For any of the above described methods for determining white space, the storage marker used for indicating the white space is cleared 304. The primary page is then rendered 406 while utilizing one of the methods described above, or other method, for determining white space such as i) marking each pel as it is overlaid or rendered 311, ii) computing the rendered shape and storing the area 312, or iii) computing the area and storing the area in DOM with the rendered object 313. The white space filler is then rendered 322. The filler may be an advertisement, the weather, the time, stock quotes, watermarks, news or sports updates, personal finance information, or other information. The method then waits for the next paint command, 324, such as a user scroll action, frame resize, page down, etc. When such a user action is received that would change the current display, the process repeats itself by rendering the white space filler in an appropriately sized white space area.

There are several embodiments of the present invention =which utilize the available white space to reposition secondary Web page content (or the associated object) such as an advertising frame, logos, watermarks, graphics, important news events, etc., within the primary Web page.

In one embodiment, the secondary content remains at a relatively fixed position within the primary frame of the primary Web page document as the primary content is scrolled by repositioning the primary Web page content, i.e., the data elements, around the browser object containing the secondary content.

In another embodiment, the secondary Web page content is repositioned in the primary Web page document as the primary Web page is scrolled by minimizing any change to the original overall layout of the primary document while maximizing the ability to show the secondary Web page content. In this embodiment, the browser finds white space having a size that can accommodate the secondary Web page content, and its associated object, and pops the secondary Web page content into this area.

In addition, if a primary browser frame having a rendered primary Web page is resized such that an embedded secondary object would no longer be viewable within the resized frame, a preferred embodiment of the invention will relocate the embedded secondary object within the rendered primary Web page. The prior art technique of popping up new frames containing advertisement content which may obscure portions of the primary Web page is no longer necessary. Instead, the advertising content is repositioned within the current frame containing the primary Web page. This is possible because it is the browser that determines when a primary frame is resized in such a way that a specific browser object would no longer be viewable. As such, the present invention ensures that certain objects, embedded in the primary Web page and obscured because they have been scrolled off the screen or because the Web page frame has been resized, remain displayed.

Although a preferred embodiment comprises a viewer program using flowed content, the present invention is also applicable to viewer programs using fixed content. In such embodiments, the viewer program would superimpose the secondary content on the available fixed white space. However, the viewer program would not be able to create any white space. Nevertheless, if white space were not available, the viewer program would display the secondary content over the primary content for only a finite period of time, or until white space was found in the displayed portion of the document that could, at least partially accommodate the secondary content. Even if the white space could not completely accommodate the secondary content, whatever portion it could accommodate would minimize the amount of primary content that would be obscured.

The creator of a Web page can designate that certain content, embedded objects or frames always remain viewable. The content owner (such as an advertiser owner) can also designate that any embedded object containing its content be always shown. In addition, the browser may generate its own browser object to be always shown. It does not have to be a full frame window; it can be any graphic, document, section of text, section of links, etc.

The browser receives the designation of which embedded objects are to remain visible through the use of meta data tags that are compatible with the Hypertext Markup Language as it exists today. Alternatively, new tags can be created for indicating that an object is to be treated by the browser in a special way so that it remains visible regardless of user actions such as scrolling or resizing of a primary Web page frame. The designation information can also be sent down to the browser on a separate download channel.

For example, the designation information can be inserted into an image source tag. An example of an image source tag is as follows:

<img src=“/images/v6/odot.gif” width=“10” height=“20”/>

If the image is to be stretched to fit within a white space, the designation information may be denoted as:

stretchToFit=“true”.

If the image is to always remain on the screen, the designation information may be denoted as:

alwaysonscreen=“true”

If the image is to only remain on the screen for a certain period of time, the designation information may be denoted as:

timeslice=“5”

The timeslice designation enables the corresponding image, i.e., secondary content, to only be on the screen for the designated amount of time. After the designated time period is over, the browser would no longer look for white space to display the secondary content. Alternatively, this timeslice designation also allows other images, i.e., other secondary content, to be designated for a certain period of time. As such, the same available white space can be used to cycle through, or rotate or alternate, several different sources of secondary content.

As such, the above designations can be inserted into the image source tag as follows:

<img src=“/images/v6/odot.gif” stretchToFit=“true” alwaysonscreen=“true” timeslice=“5” width=“10” height=“20”/>

It should be noted that the designation information can be used on any type of tag, not just image source tags.

The above changes in tag content would require a change in the HTML standard. Alternatively, instead of embedding the above designation information in tags, the designation information can be put into a database utilized by the viewer program where the fully qualified URL to the image source is the key and the designation information is the data. Still yet, the designation information could also be placed in meta tags as meta data.

In a preferred embodiment of the present invention, a new application programming interface (API) in the document object model for determining a white space hole in a Web page document is provided. The API architecture of the present invention provides new capabilities to programs. A new application programming interface (API) enables application programs and programming scripts to determine size and location of white space areas in a Web page. More specifically, application programs and programming scripts can request a white space of a given size within the Web page document. The browser will either return a list of white space areas matching the requested white space size; or, if there are not any white spaces matching the requested size, the program can request that a white space of a given size be created. In response to the request, the browser will reflow the Web page document until the requested white space size has been generated. As such, the Web page document is edited automatically on the fly using the document object model as provided by a browser or a document viewer. Images and text in a document are automatically moved around in order to generate more white space of a given size or to identify a location of the white space. Furthermore the browser ensures that certain attributes as specified by the document owner or customer are provided for in the Web page.

For example, an enterprise's Web page may contain the company's logo. The Web page owner, i.e., the enterprise, may specify that the company's logo always remain visible on the Web page regardless of how the Web page is scrolled or sized. Consequently, not only will the logo always be visible to the user; but if a user requests a print screen, the company logo will always appear on the printout. Likewise, an object area that is to be provided as advertising space can be associated with attributes that designate the object space as an area that is always to remain visible. As such, whatever advertisement is retrieved for that object space will remain visible. The user will not be able to scroll the advertisement off of the screen. Likewise, there is no need for the browser to pop up additional frames containing the advertisement or similar advertisements since the advertisement will remain viewable. The advertisement remains visible by relocating to other preexisting white space of by having the browser reflow the content of the document to create white space for the advertisement.

The present invention can be implemented in a Web browser, a document viewer, or a plug-in installed on the browser and executed against the docoument object model on the fly, i.e., in real time as the content is being rendered on the screen. Alternatively, every Web page can have a DOM white space installer.

Alternatively, the present invention can be implemented in a server where the rendering and layout takes place on a remote box and the finally rendered document is sent to the display of the client. This alternative implementation would be advantageous when, for example, the client is a personal digital assistant or other hand held device.

An instantiation of the invention enables a user to receive information (such as advertisements, stock quotes, personalized financial reports, news updates, or other information) persistently inside the primary document without obscuring the content of the rendered document. The information is persistent in the primary document regardless of whether or not the primary document is being scrolled or the frame containing the primary document is being resized. As a result, no annoying frames need to keep popping up at a user in order to keep such information in front of the user.

It is intended that the scope of the invention be limited not by this detailed description, but rather by the claims appended hereto. The above specification, examples and data provide a complete description of the manufacture and use of the system, method, and article of manufacture, i.e., computer program product, of the invention. Since many embodiments of the invention can be made without departing from the spirit and scope of the invention, the invention resides in the claims hereinafter appended.

Having thus described the invention, what we claim as new and desire to secure by Letters Patent is set forth in the following claims.

1. A method for rendering a document on a display utilizing a viewer program running on a computer system, comprising:
receiving primary content of the document to be displayed;
identifying secondary content to be displayed in conjunction with the primary content;
determining whether there is available white space within the primary content, when displayed within a display area, to accommodate the secondary content; and
performing at least one of:
embedding the secondary content in the available white space if it is determined that there is available white space to accommodate the secondary content; and
reflowing the primary content to form suitable white space in the displayed area and embedding the secondary content in the suitable white space formed.

2. The method of claim 1 further comprising receiving a user action to change a display of the primary content in the displayed area; and reiterating determining available white space and performing at least one of embedding the secondary content and reflowing the primary content.

3. The method of claim 2 wherein the user action comprises at least one of a resizing of the display area and a scrolling of the primary content.

4. The method of claim 1 wherein the white space is a background to the primary content.

5. The method of claim 1 wherein identifying secondary content comprises receiving a designation associated with receiving secondary content indicating that the secondary content is to be persistently displayed within white space of the document.

6. The method of claim 5 wherein receiving a designation further comprises retrieving the designation from a database accessible to the viewer program.

7. The method of claim 1 wherein identifying secondary content comprises generating a viewer object containing the secondary content.

8. The method of claim 1 further comprising automatically resizing the secondary content to fill the determined white space.

9. The method of claim 1 wherein the step of determining whether there is available white space further comprises determining the areas of the data elements used through a Document Object Model Interface.

10. The method of claim 1 wherein the step of reflowing the primary content further comprises making changes to the document Object Model tree and reflowing the document according to the changes.

11. The method of claim 1 wherein identifying secondary content to be displayed in conjunction with the primary content further comprises identifying secondary content having a time based designation for causing at least one of i) an alternating of the display of the secondary content with other designated secondary content in a same white space, and ii) a displaying of the identified secondary content in the white space for only the time period specified.

12. A computer program, on a computer usable medium, having program code means for rendering a document on a display, comprising:
means for receiving primary content of the document to be displayed;
means for identifying secondary content to be displayed in conjunction with the primary content;
means for determining whether there is available white space within the primary content, when displayed within a display area, to accommodate the secondary content; and
means for performing at least one of:
embedding the secondary content in the available white space if it is determined that there is available white space to accommodate the secondary content; and
reflowing the primary content to form suitable white space in the displayed area and embedding the secondary content in the suitable white space formed.

13. The computer program of claim 12 further comprising means for identifying a user action to change a display of the primary content in the displayed area; and means for re-invoking the means for determining available white space and the means for performing at least one of embedding the secondary content and reflowing the primary content.

14. The computer program of claim 12 wherein the means for identifying secondary content further comprises means for receiving a designation associated with receiving secondary content indicating that the secondary content is to be persistently displayed within white space of the document.

15. The computer program of claim 12 wherein the means for identifying secondary content comprises means for generating a viewer object containing the secondary content.

16. The computer program of claim 12 further comprising means for automatically resizing the secondary content to fill the determined white space.

17. The computer program of claim 12 wherein means for identifying secondary content to be displayed in conjunction with the primary content further comprises means for identifying secondary content having a time based designation for causing at least one of i) an alternating of the display of the secondary content with other designated secondary content in a same white space, and ii) a displaying of the identified secondary content in the white space for only the time period specified.

18. The computer program of claim 12 wherein the means for determining whether there is available white space further comprises means for determining the areas of the data elements used through a Document Object Model Interface.

19. A computer system running a viewer program having means for rendering a document on a display, comprising:
means for receiving primary content of the document to be displayed;
means for identifying secondary content to be displayed in conjunction with the primary content;
means for determining whether there is available white space within the primary content, when displayed within a display area, to accommodate the secondary content; and
means for performing at least one of:
embedding the secondary content in the available white space if it is determined that there is available white space to accommodate the secondary content; and
reflowing the primary content to form suitable white space in the displayed area and embedding the secondary content in the suitable white space formed.

20. The computer system of claim 19 further comprising means for identifying a user action to change a display of the primary content in the displayed area; and means for re-invoking the means for determining available white space and the means for performing at least one of embedding the secondary content and reflowing the primary content.

21. The computer system of claim 19 wherein the means for identifying secondary content further comprises means for receiving a designation associated with receiving secondary content indicating that the secondary content is to be persistently displayed within white space of the document.

22. The computer system of claim 19 wherein the means for identifying secondary content comprises means for generating a viewer object containing the secondary content.

23. The computer system of claim 19 wherein the means for receiving a designation further comprises means for retrieving the designation from a database accessible to the viewer program.

24. The computer system of claim 19 further comprising means for automatically resizing the secondary content to fill the determined white space.

25. The computer system of claim 19 wherein the means for determining whether there is available white space further comprises means for determining the areas of the data elements used through a Document Object Model Interface.

26. A method for sending a rendered document from a server to a client over a network, comprising:
receiving primary content of the document to be displayed;
identifying secondary content to be displayed in conjunction with the primary content;
determining whether there is available white space within the primary content, when displayed within a display area, to accommodate the secondary content;
performing at least one of:
embedding the secondary content in the available white space if it is determined that there is available white space to accommodate the secondary content; and
reflowing the primary content to form suitable white space in the displayable area and embedding the secondary content in the suitable white space formed; and
sending the document with the embedded secondary content to the client for display.

27. A computer system having means for sending a rendered document to a client over a network, comprising:
means for receiving primary content of the document to be displayed;
means for identifying secondary content to be displayed in conjunction with the primary content;
means for determining whether there is available white space within the primary content, when displayed within a displayable area, to accommodate the secondary content;
means for performing at least one of:
embedding the secondary content in the available white space if it is determined that there is available white space to accommodate the secondary content; and
reflowing the primary content to form suitable white space in the displayable area and embedding the secondary content in the suitable white space formed; and
means for sending the document with the embedded secondary content to the client for display.

28. A method for rendering a fixed content document on a display utilizing a viewer program running on a computer system, comprising:
receiving primary content of the document to be displayed;
identifying secondary content to be displayed in conjunction with the primary content;
determining whether there is available white space within the primary content, when displayed within a display area, to accommodate the secondary content; and
performing at least one of:
embedding the secondary content in the available white space if it is determined that there is available white space to accommodate the secondary content; and
overlaying the secondary content over a portion of the primary content for a period of time if it is determined that there is no available white space to accommodate the secondary content.

29. A computer program on a computer usable medium having computer readable program code means for rendering a fixed content document on a display, comprising:
means for receiving primary content of the document to be displayed;
means for identifying secondary content to be displayed in conjunction with the primary content;
means for determining whether there is available white space within the primary content, when displayed within a display area, to accommodate the secondary content; and
means for performing at least one of:
embedding the secondary content in the available white space if it is determined that there is available white space to accommodate the secondary content; and
overlaying the secondary content over a portion of the primary content for a period of time if it is determined that there is no available white space to accommodate the secondary content.

30. A computer system executing a viewer program having means for rendering a fixed content document on a display, comprising:
means for receiving primary content of the document to be displayed;
means for identifying secondary content to be displayed in conjunction with the primary content;
means for determining whether there is available white space within the primary content, when displayed within a display area, to accommodate the secondary content; and
means for performing at least one of:
embedding the secondary content in the available white space if it is determined that there is available white space to accommodate the secondary content; and
overlaying the secondary content over a portion of the primary content for a period of time if it is determined that there is no available white space to accommodate the secondary content.
